(19) United States
(12) Patent Application Publication
(10) Pub. No.: US 2023/0360065 A1
(43) Pub. Date: Nov. 9, 2023

(54) Automated Identification of Entities in Job Titles for Predictive Modeling

(71) Applicant: 6SENSE INSIGHTS, INC., San Francisco, CA (US)

(72) Inventors: Kelly Huang, San Francisco, CA (US); Daniel Carmody, Durham, NC (US); Yulia Tyutina, Minneapolis, MN (US)

(21) Appl. No.: 18/142,730

(22) Filed: May 3, 2023

Related U.S. Application Data
(60) Provisional application No. 63/337,896, filed on May 3, 2022.

(51) Int. Cl. G06Q 30/0202; G06N 5/022

(52) U.S. Cl. CPC G06Q 30/0202; G06N 5/022

(57) ABSTRACT

The diversity of job titles prevents the extraction of information from job titles to be automated and scalable. Accordingly, disclosed embodiments utilize a machine-learning named-entity recognition model to tokenize job titles, and tag those tokens according to one or more named entities, such as job responsibility and job function. The named entities may be extracted from the tagged tokens to be used as an input to a persona model that predicts a persona score, indicating the relative importance of a person to a sales opportunity. This enables granular information to be automatically extracted from job titles, regardless of structure, style, or format, without continual retraining and in a scalable manner, for use in one or more downstream functions.

### CROSS-REFERENCE TO RELATED APPLICATIONS

This application claims priority to U.S. Provisional Pat. App. No. 63/337,896, filed on May 3, 2022, which is hereby incorporated herein by reference as if set forth in full.

### BACKGROUND

### Field of the Invention

The embodiments described herein are generally directed to predictive modeling, and, more particularly, to the automated identification of entities in job titles for predictive modeling.

### Description of the Related Art

In business-to-business (B2B) marketing, personas can help a company organize its customers (e.g., existing and/or potential customers) into groups. In particular, personas that share one or more similar or identical characteristics can be grouped together. These groupings allow the company to analyze customer behavior and build marketing strategies, so that the company can methodically and deliberately target its sales efforts to each group. As an example, U.S. Pat. Publication No. 2021/0406933 (“the ‘933 publication”), published on Dec. 30, 2021, which is hereby incorporated herein by reference as if set forth in full, describes one manner in which personas can be used for targeted marketing.

Any utilization of personas can benefit from an understanding of the job title of the person represented by the persona. This person may be an existing contact at an existing customer, an existing contact at a potential customer, a lead at an existing customer, a lead at a potential customer, or the like. In each case, the job title provides context about the person’s role at the customer, as well as the person’s expertise. Knowledge about roles and expertise enables personas to be grouped into more granular target segments.

However, across all industries, job titles tend to be messy and unstandardized. Some may be short and/or formulaic, whereas others may be long and/or creative. This makes it impossible to automate and scale the determination of role and expertise from job titles. Traditionally, this task must be performed manually. The present disclosure is directed towards overcoming this and other problems discovered by the inventors.

### SUMMARY

Systems, methods, and non-transitory computer-readable media are disclosed to automate the identification of entities, such as job responsibility and job function, in job titles for persona-based predictive modeling.

In an embodiment, a method comprises using at least one hardware processor to, for each of one or more persons: receive a job title associated with the person; apply a named-entity recognition model to the job title to identify one or more entities in the job title, wherein the one or more entities comprise one or both of a job responsibility or a job function; generate a persona comprising one or more attributes of the person, wherein the one or more attributes include the identified one or more entities; and apply a persona model to the one or more attributes to predict a persona score for the persona, wherein the persona score indicates a relative importance of the person to sales opportunities.

The method may further comprise before applying the named-entity recognition model to the job title, standardizing the job title. Standardizing the job title may comprise expanding contractions and abbreviations.

The named-entity recognition model may be a Bidirectional Representations from Transformers (BERT) language model. The named-entity recognition model may be a Distilled Bidirectional Representations from Transformers (DistilBERT) language model.

Applying the named-entity recognition model to the job title may comprise: applying a tokenizer to the job title to convert the job title into a sequence of tokens; and tag each token in the sequence of tokens according to a tagging schema for the one or more entities. The tagging schema may be a beginning, inside, outside, ending, and single (BIOES) tagging schema, in which there is a beginning, inside, ending, and single tag for each of the one or more entities, and an outside tag for any token that does not represent any of the one or more entities. The tokenizer may be an uncased tokenizer. The method may further comprise, prior to applying the named-entity recognition model, training the named-entity recognition model using a training dataset in supervised learning, wherein the training dataset comprises tokenized job titles labeled with ground-truth tags.

The one or more entities may comprise the job responsibility. The one or more entities may comprise the job function. The one or more entities may be a plurality of entities, including both the job responsibility and the job function.

The method may further comprise storing the persona, in association with the persona score, in a master people database. The one or more entities may be a plurality of entities, including both the job responsibility and the job function, and the method may further comprise generating a persona map, based on personas in the master people database, wherein the persona map comprises a first dimension representing a plurality of different job responsibilities, and a second dimension representing a plurality of different job functions. The persona map may comprise a two-dimensional grid with a plurality of cells, wherein each of the plurality of cells represents a pairing of a job responsibility in the first dimension with a job function in the second dimension. Each of the plurality of cells may indicate a number of personas, having the pairing of job responsibility and job function represented by the cell, in each of one or more categories. Each of the plurality of cells may have a color in accordance with a color coding scheme, wherein the color coding scheme assigns a color within a color spectrum to each of the plurality of cells based on the persona scores associated with personas having the pairing of job responsibility and job function represented by that cell.

The one or more persons may be a plurality of persons, and the method may further comprise using the at least one hardware processor to provide the personas, generated for the plurality of persons, to a recommendation engine that generates a list of recommended contacts based on the persona scores of the personas.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a process for training a machine-learning model for automatically tagging a job title, according to an embodiment;

FIG. 4 illustrates a process for operating a machine-learning model for automatically tagging a job title, according to an embodiment;

FIG. 5 illustrates an example machine-learning model for extracting entities from a job title;

FIG. 6 illustrates a process for operating a machine-learning model to score personas, according to an embodiment; and

FIG. 7 illustrates an example of a screen comprising a persona map, according to an embodiment.

### DETAILED DESCRIPTION

In an embodiment, systems, methods, and non-transitory computer-readable media are disclosed for automated identification of entities, such as job responsibility and job function, in job titles for persona-based predictive modeling. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

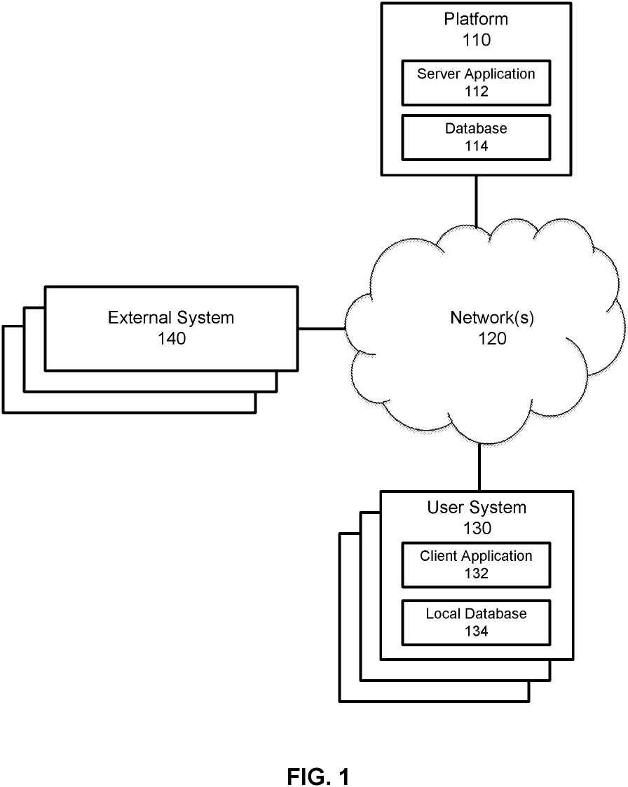

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may execute a server application 112 and provide access to a database 114. In addition, platform 110 may be communicatively connected to one or more user systems 130 via one or more networks 120. Platform 110 may also be communicatively connected to one or more external systems 140 (e.g., other platforms, including third-party data sources, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one database 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that user system 130 will comprise the workstation or personal computing device of an agent (e.g., sales or marketing representative, data scientist, etc.) of a company in the B2B industry with an account on platform 110, or an agent (e.g., programmer, developer, etc.) of the operator of platform 110. Each user system 130 may execute a client application 132 with access to a local database 134.

External system(s) 140 may also comprise any type or types of computing devices capable of wired and/or wireless communication, including those described above. However, it is generally contemplated that external system 140 will comprise a server-based system that hosts customer relationship management (CRM) software, marketing automation platform (MAP) software, a website, and/or the like, or the system of a third-party data vendor or other data source. External system 140 may send data to platform 110 (e.g., contacts or leads at existing or potential customers, website or other online activity, offline activity, marketing activity, etc.) and/or receive data from platform 110 (e.g., recommendations or other information about contacts or leads, new leads, etc.). In this case, external system 140 may “push” and/or “pull” data through an application programming interface (API) of platform 110, and/or platform 110 may “push” and/or “pull” data through an API of external system 140.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 may transmit or serve one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in database 114. It should be understood that platform 110 may also respond to other requests from user system(s) 130 that are unrelated to the graphical user interface.

Platform 110 may comprise, be communicatively coupled with, or otherwise have access to database 114. For example, platform 110 may comprise one or more database servers which manage database 114. Server application 112 executing on platform 110 and/or client application 132 executing on user system 130 may submit data (e.g., user data, form data, etc.) to be stored in database 114, and/or request access to data stored in database 114. Any suitable database may be utilized, including without limitation MySQL™, Oracle™, IBM™, Microsoft SQL™, Access™, PostgreSQL™, MongoDB™, and/or the like, including cloud-based databases and/or proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an API which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user systems 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 2. Example Processing System

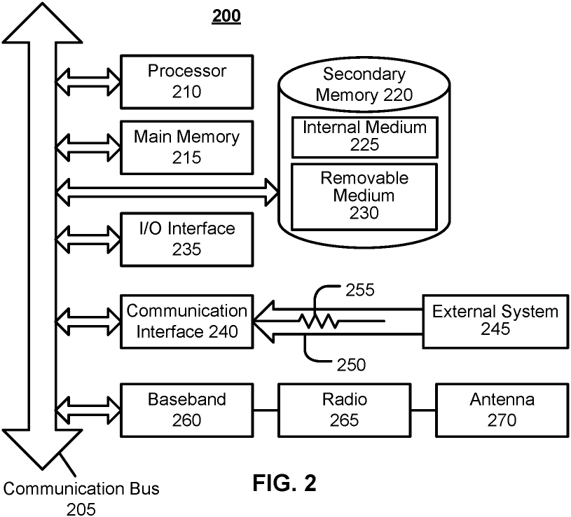

FIG. 2 is a block diagram illustrating an example wired or wireless processing system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or supporting data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or supporting data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

Any of the described processes may be embodied in one or more software modules that are executed by processor(s) 210 of one or more processing systems 200, for example, as a service or other software application (e.g., server application 112, client application 132, and/or a distributed application comprising both server application 112 and client application 132), which may be executed wholly by processor(s) 210 of platform 110, wholly by processor(s) 210 of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component is for ease of description. Specific functions can be moved from one component to another component without departing from the disclosure.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 3. Training

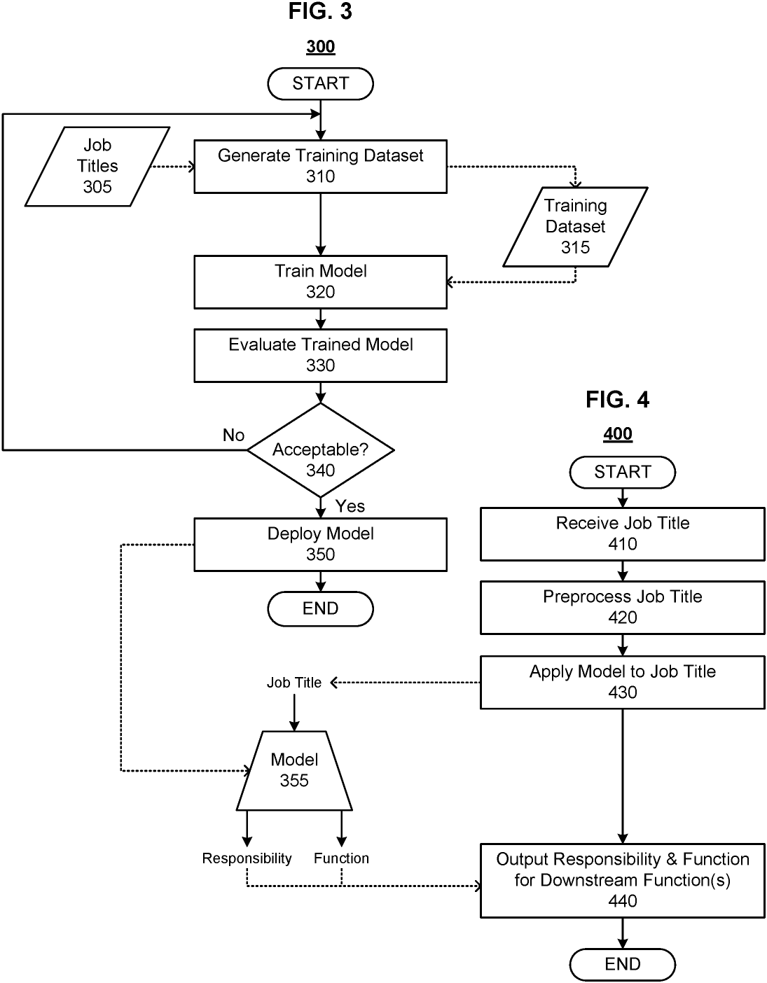

FIG. 3 illustrates a process 300 for training a machine-learning model for automatically tagging a job title, according to an embodiment. Process 300 may be performed under the direction of an agent (e.g., developer) of the operator of platform 110, to produce a machine-learning model that can be used to process job titles in an operational stage on platform 110.

The input to process 300 may be a job-title dataset 305 comprising or consisting of job titles. As used herein, the term “job title” refers to any string of one or more words, whether a name, phrase, sentence, sentence fragment, paragraph, narrative, or otherwise, that describes a person’s job. Job titles tend to be very diverse, and will vary across different people, companies, and personalities.

In subprocess 310, a training dataset 315 is generated from job-title dataset 305. In an embodiment, training dataset 315 comprises standardized job titles that are each tokenized, with each token being labeled with a ground-truth tag. Each ground-truth tag may be one of a finite set of tags. At least some of the tags in the finite set of tags represent one or more named entities. Of particular relevance to disclose embodiments, the named entities, represented in the tags, may comprise or consist of a job responsibility and/or a job function. As used herein, the term “job responsibility” represents the role and duty of the person, and may indicate managerial level (e.g., director, manager, lead, etc.), seniority level (e.g., senior, vice, assistant, associate, etc.), and/or operational role (e.g., engineer, accountant, technician, etc.). As used herein, the term “job function” refers to a description of the business function(s), performed by the person, in one or more dimensions, such as department (e.g., sales, marketing, operations, etc.), scope (e.g., enterprise, project, national, regional, etc.), and/or content of work (e.g., data, research and development, security, etc.). While the job responsibility and job function will be used as the primary examples of named entities described herein, it should be understood that the finite set of tags may also comprise one or more tags that represent other named entities, such as location or other job attribute.

There may also be an “outside” tag for any token that does not represent any named entity. In an embodiment, the finite set of tags consists only of tag(s) for job responsibility, tag(s) for job function, and an outside tag that is assigned to any token that does not represent either a job responsibility or a job function. Any token that is tagged with the outside tag may be considered as irrelevant to any downstream functions.

In an embodiment, training dataset 315 utilizes the beginning, inside, outside, ending, and single (BIOES) tagging schema. In other words, each token in the job title is labeled as either the beginning (B) of a named entity, on the inside (I) of a named entity, on the outside (O) of a named entity (i.e., the token belongs to no named entity), at the end (E) of a named entity, or a single (S) token that represents a named entity. In the examples depicted herein, the named entity for job responsibility may be represented as “RES,” and the named entity for job function may be represented as “FUN.” Thus, the set of possible tags for each token consists of B-RES (i.e., a token at the beginning of a sequence of tokens representing job responsibility), I-RES (i.e., a token inside a sequence of tokens representing job responsibility), E-RES (i.e., a token at the end of a sequence of tokens representing job responsibility), S-RES (i.e., a token representing job responsibility by itself, without any adjacent tokens representing job responsibility), B-FUN (i.e., a token at the beginning of a sequence of tokens representing job function), I-FUN (i.e., a token inside a sequence of tokens representing job function), E-FUN (i.e., a token at the end of a sequence of tokens representing job function), S-FUN (i.e., a token representing job function by itself, without any adjacent tokens representing job function), and O (i.e., a token that does not meet the criteria of any of the other tags).

In an embodiment, the job titles in training dataset 315 may be standardized. In particular, any word that is open to variation may be standardized to a single word. For example, contractions may be expanded (e.g., “I’ve” to “I have”), abbreviations may be expanded (e.g., “VP”, “V P″, V.P.”, “Vice Pres.”, etc., may all be expanded to “vice president”), typographical errors may be corrected, punctuation marks may be replaced with spaces or removed, and/or the like. Contractions, abbreviations, or other source of variation that are ambiguous may be maintained as-is. As a result of the standardization, training dataset 315 will comprise a clean, standardized set of job titles that are consistent across all organizations. This consistency may improve the performance of the machine-learning model.

In an embodiment, training dataset 315 may be generated from the publicly available Industrial and Professional Occupations Dataset (IPOD), which is described in Liu et al., “IPOD: An Industrial and Professional Occupations Dataset and its Application to Occupational Data Mining and Analysis,” arXiv:1910.10495v2, Apr. 26, 2020, which is hereby incorporated herein by reference as if set forth in full. IPOD comprises over 190,000 English-language job titles, crawled from over 56,000 profiles from LinkedIn™. Each of the job titles is tokenized and tagged to denote the named entities of responsibility, function, and location.

In a particular implementation that used the IPOD, the IPOD was restructured into just the tokenized job titles and their corresponding ground-truth tags. The job titles were standardized, as described above, and any tags for location were converted into outside tags. In addition, training dataset 315 was optimized by adding job titles that are particularly relevant in the B2B context with corresponding ground-truth tags, and by manually editing certain ground-truth tags to better align with goals in the B2B context. As one example, in IPOD the name “Salesforce” is tagged with the outside tag. However, in the B2B context, Salesforce™, which is a CRM platform, generally represents a job function. Thus, for training dataset 315, outside tags assigned to “Salesforce” were changed to function tags. More generally, trademarks, brand names, or other marks or names (e.g., associated with software-based platforms, software applications, or other software or hardware tools or services relevant to the B2B context), which may be representative of a job function, can be edited in a similar manner.

In subprocess 320, the model is trained using training dataset 315. In particular, the model may be trained from the tokenized job titles, labeled with ground-truth tags, in training dataset 315, using supervised learning. In an embodiment, the model implements a named-entity recognition (NER) task. The objective of named-entity recognition, which may also be referred to as entity identification, entity chunking, or entity extraction, is to locate and classify named entities in unstructured text into a finite set of classes using the finite set of tags described herein. Of particular relevance to disclosed embodiments, the model tokenizes the unstructured text, and then classifies each of the tokens as representing either a job responsibility (RES), job function (FUN), or neither (O). Because tagging tokens within a job title is similar to a multi-classification task, named-entity recognition is commonly treated as a multi-classification problem. However, named-entity recognition has some advantages over multi-classification models, as described elsewhere herein.

In an embodiment, the model comprises or consists of a Bidirectional Representations from Transformers (BERT) language model for the NER task. BERT is described in Devlin et al., “BERT: Pre-training of Deep Bidirectional Transformers for Language Understanding,” arXiv:1810.04805v2, May 24, 2019 (“Devlin”), which is hereby incorporated herein by reference as if set forth in full. In particular, the model may be a Distilled BERT (DistilBERT) language model, as described, for example, in Sanh et al., “DistilBERT, a distilled version of BERT: smaller, faster, cheaper and lighter,” arXiv:1910.01108v4, Mar. 1, 2020 (“Sanh”), which is hereby incorporated herein by reference as if set forth in full. DistilBERT is a distilled version of the BERT base model which is used to increase inference speed during operation. According to Sanh, the DistilBERT model is 40% smaller than the BERT model and 60% faster than the BERT model, while retaining 97% of the language understanding capabilities of the BERT model.

In an embodiment, the DistilBERT model was fine-tuned for the named-entity recognition task on job titles. The model may utilize the pretrained DistilBERT base uncased tokenizer, from the HuggingFace™ Transformers Library, to tokenize the job titles. An uncased tokenizer is preferable, because letter casing is not necessary for the understanding of job titles. The DistilBERT base uncased tokenizer uses the WordPiece tokenizer to split each job title into a sequence of sub-word tokens. The WordPiece tokenizer is described, for example, in Wu et al., “Google’s Neural Machine Translation System: Bridging the Gap between Human and Machine Translation,” arXiv:1609.08144v2, Oct. 8, 2016, which is hereby incorporated herein by reference as if set forth in full.

In a particular implementation, the DistiBERT named-entity recognition model was configured to allow for a maximum job title length of thirty-two (32) tokens during training. The tokens from each job title in training dataset 315 were split into sub-tokens, and each job title was padded to a length of thirty-two tokens, including a classification token “[CLS]” to identify a classification task and a separator token “[SEP]” to separate inputs to the classification task. The training batch size was set to thirty-two (32), the validation batch size was set to eight (8), and the number of epochs was set to three (3). A 30% dropout rate was used during training to prevent overfitting. The cross-entropy loss function was used as the loss function during training.

In subprocess 330, the model, trained in subprocess 320, may be evaluated. The evaluation may comprise validating and/or testing the model using a portion of training dataset 315 that was not used to train the model in subprocess 320. The result of subprocess 330 may be a performance measure for the model, such as an accuracy of the model. The evaluation in subprocess 330 may be performed in any suitable manner.

In subprocess 340, it is determined whether or not the model, trained in subprocess 320, is acceptable based on the evaluation performed in subprocess 330. For example, the performance measure from subprocess 340 may be compared to a threshold or one or more other criteria. If the performance measure satisfies the criteria (e.g., is greater than or equal to the threshold), the model may be determined to be acceptable (i.e., “Yes” in subprocess 340). Conversely, if the performance measure does not satisfy the criteria (e.g., is less than the threshold), the model may be determined to be unacceptable (i.e., “No” in subprocess 340). When the model is determined to be acceptable (i.e., “Yes” in subprocess 340), process 300 may proceed to subprocess 350. Otherwise, when the model is determined to be unacceptable (i.e., “No” in subprocess 340), process 300 may return to subprocess 310 to retrain the model (e.g., using a new training dataset 315).

In subprocess 350, the trained model may be deployed as model 355. In an embodiment, model 355 receives a job title as an input, and outputs the named entities (e.g., job responsibility and/or job function) identified in that job title. Model 355 may be deployed by moving model 355 from a development environment to a production environment. For example, model 355 may be made available at an address on platform 110 (e.g., in a microservice architecture) that is accessible to a predictive model or other service or application that utilizes model 355.

To increase the inference speed of model 355, model 355 may be exported from the format in which it was developed (e.g., Pytorch™) into the Open Neural Network Exchange (ONNX) format. The ONNX format is an open format that enables model 355 to be moved between various machine-learning frameworks and tools. Additionally or alternatively, the weights of model 355 may be quantized into 8-bit integer values, instead of 32-bit floating-point values. Quantization of the weights increases the inference speed of model 355, with equivalent results and similar performance. The files, representing model 355, may be built into the Python™ Executable (PEX) format, such that they are self-contained executable Python™ virtual environments, and incorporated into a user-defined function in Apache Hive™. Apache Hive™ is a data warehouse software project, built on Apache Hadoop™, for providing data query and analysis.

### 4. Operation

FIG. 4 illustrates a process 400 for operating a machine-learning model 355 for automatically tagging a job title, according to an embodiment. Process 400 may be executed as a subroutine within a larger software service or application. Alternatively, process 400 may be executed as its own service (e.g., in a microservice architecture), which is accessible at a particular address to other services or applications. In either case, the input to process 400 may be a job title, and the output of process 400, may be the named entities identified in the job title (e.g., job responsibility and/or job function).

Initially, in subprocess 410, at least one job title may be received. Each job title may be represented in a string or other data type. In an embodiment, the job title(s) may be passed as an input parameter by a caller of process 400. The job title(s) may be received as individual inputs to process 400, or a plurality of job titles may be processed by process 400 as a batch.

In subprocess 420, the job title(s), received in subprocess 410, may be preprocessed. Preprocessing may comprise standardizing each job title in the same manner as the job titles were standardized in subprocess 310 to produce training dataset 315. In particular, any word that is open to variation may be standardized to a single word. For example, contractions may be expanded, abbreviations may be expanded, punctuation marks may be replaced with spaces or removed, and/or the like. Contractions, abbreviations, or other source of variation that are ambiguous may be maintained as-is. Thus, each job title that is input to model 355 during operation will be consistent with the job titles that were used to train model 355.

In subprocess 430, model 355, which was trained in subprocess 320 of process 300 and deployed by subprocess 350 of process 300, may be applied to the preprocessed job title(s), output by subprocess 420. In particular, each job title is input into model 355. Model 355 may be applied to individual job titles or, when there are a plurality of job titles to be processed, batches of job titles, for faster processing.

In an embodiment, model 355 identifies each named entity, if any, in each job title. In a particular embodiment, model 355 infers both a job responsibility and a job function from each job title. It should be understood that not every job title may comprise both a job function and a job title. Model 355 outputs whatever it finds, which may comprise a job responsibility and a job function, just a job responsibility, just a job function, or neither a job responsibility nor a job function. If model 355 is trained to identify other named entities in job titles, any of those other named entities that are found in the job title will also be output in subprocess 430.

In subprocess 440, the output of model 355, which includes any named entities (e.g., job responsibility and/or job function) identified in each job title, may be output. For example, the output may be returned as a response to the caller of process 400. This output may be used by the caller for one or more downstream functions, such as predictive modeling, as discussed elsewhere herein. Each named entity, such as job responsibility and/or job function, may be represented in a string or other data type.

### 5. Model

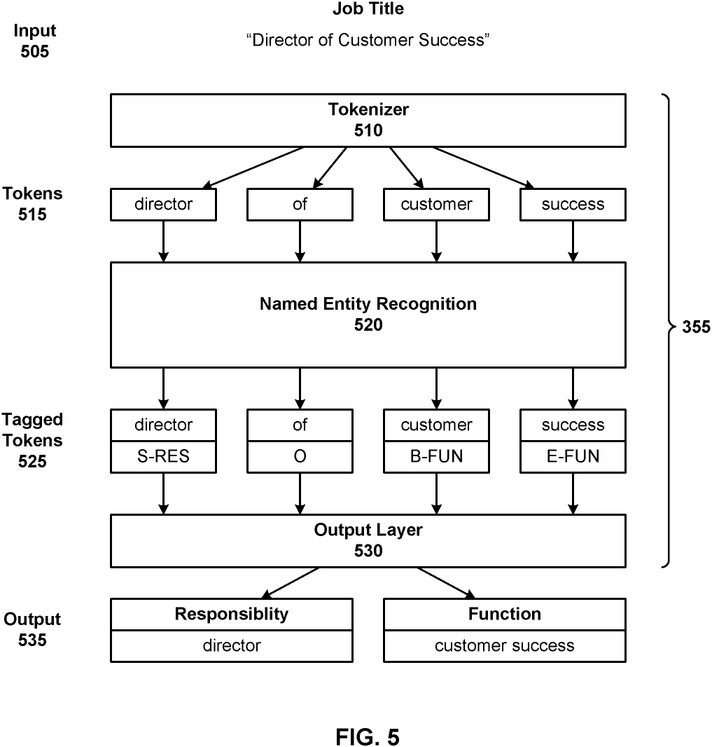

FIG. 5 illustrates an example machine-learning model 355 for extracting named entities from a job title, according to an embodiment. As illustrated, model 355 may comprise a tokenizer 510, a named-entity recognition model 520, and an output layer 530. For purposes of illustration, a job title of “Director of Customer Success” is used as an example of input 505 to model 355.

Initially, tokenizer 510 receives input 505 and outputs a set of tokens 515. For example, tokens 515 may consist of “director”, “of”, “customer”, and “service” tokens. As discussed elsewhere herein, tokenizer 510 may comprise or consist of the DistilBERT base uncased tokenizer. However, it should be understood that other tokenizers could be used for tokenizer 510.

Named-entity recognition model 520 receives tokens 515 as input, and outputs a set of tagged tokens 525. As discussed elsewhere herein, named-entity recognition model 520 may comprise or consist of a DistilBERT model, which may be fine-tuned and/or enhanced for the B2B context. However, it should be understood that other models, including the BERT base model or variants thereof, may be used for named-entity recognition model 520.

Tagged tokens 525 may have a one-to-one correspondence to tokens 515. Tagged tokens 525 may be tagged according to the BIOES tagging schema, for a set of one or more named entities comprising or consisting of job responsibility and job function. For example, the tagged tokens 525 may comprise a tag of “S-RES” for the “director” token, representing that “director” is a single token representing job responsibility, a tag of “O” for the “of” token, representing that “of” is outside the named entities being identified, a tag of “B-FUN” for the “customer” token, representing that “customer” is the beginning token in a sequence of tokens representing job function, and a tag of “E-FUN” for the “success” token, representing that “success” is the ending token in the sequence of tokens representing job function.

Output layer 530 receives tagged tokens 525 as input, and outputs the named entities, if any, identified in input 505, as output 535. Output layer 530 may concatenate or otherwise group all of the tokens in tagged tokens 525 that have been tagged with a given named entity into a single string representing that named entity. For example, output layer 530 may concatenate or otherwise group all of the tokens in tagged tokens 525 that have been tagged as representing job responsibility into a single string representing job responsibility in output 535, and concatenate or otherwise group all of the token in tagged tokens 525 that have been tagged as representing job function into a single string representing job function in output 535. Continuing the example above, output 535 may comprise a string of “director” for job responsibility, and a string of “customer success” for job function.

### 6. Example Applications

Disclosed embodiments of model 355 use named-entity recognition. This enables the extracted named entities (e.g., job responsibility and/or job function) to take any form and evolve over time, as job titles change. This is in contrast to multi-classification models, which would limit identification of the job responsibility and job function to a finite set of fixed classes.

In the multi-classification approach, if the information does not fit into one of the fixed classes on which the model was trained, it will be lost to downstream functions. Thus, the finite set of fixed class must be continually refined, which requires the multi-classification model to be continually retrained.

In addition, the output of a multi-classification model consists of the name of a single one of the fixed classes. This class name is all any downstream functions will receive. Thus, any additional information from the specific text, which was classified into the class, will be lost to the downstream functions. Advantageously, disclosed embodiments of model 355 allow all of the information to be captured, regardless of the structure, style, or format of job titles, and robust to the evolution of job titles, to inform one or more downstream functions at the highest level of granularity.

In an embodiment, process 400, which applies model 355, is used in a larger software application, which may be implemented as a service. For example, process 400 may extract at least the job responsibility and/or job function from job titles, to provide context to or otherwise inform customer personas for various B2B goals. These customer personas may be generated by a downstream function that uses the extracted information. Due the flexibility of model 355, which uses named-entity recognition to retain more granular information (e.g., relative to multi-classification), more granular customer personas can be generated. The granularity of the extracted information also enables the customer personas to be dynamically tuned for specific, targeted needs.

It should be understood that a downstream function may generate the customer personas based on other information, in addition to job responsibility and/or job function, and potentially including other information extracted from the job titles. For instance, the disclosed model 355 may be paired with a multi-classification model to provide job responsibility and/or job function, as discussed herein, as well as one or more classifications of the job title (e.g., job level, job function, etc.) to the persona-generation function. The combined information may expand the understanding of customer personas and/or enable new customer personas to be captured.

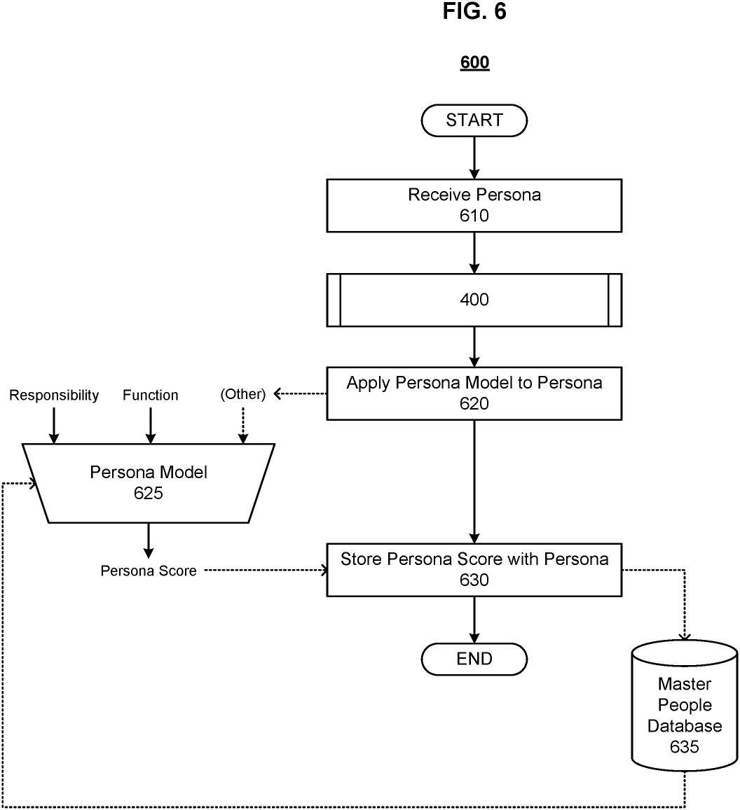

FIG. 6 illustrates a process 600 for operating a machine-learning model to score personas, according to an embodiment. Process 600 may be executed as a subroutine within a larger software application. Alternatively, process 600 may be executed as its own software application (e.g., as a service in a microservice architecture), which is accessible at a particular address to other applications (e.g., other services). In either case, the input to process 600 may be a persona, and the output of process 600, may be a persona score. It should be understood that process 600 represents an example of one downstream function which may utilize process 400.

Initially, in subprocess 610, at least one persona may be received. The persona(s) may be received as individual inputs to process 600, or a plurality of personas may be processed by process 600 as a batch. Each persona may represent a person, and be represented in a data structure storing one or more attributes of the person. At least one of the attributes may be a job title associated with the person. The persona may also include other attributes, such as a name (e.g., first and last name), contact information (e.g., email address, telephone number, etc.), the company for which the person works (e.g., a company name or other company identifier), the location (e.g., company site) at which the person works (e.g., address, city, state, Zip code, etc.), activity information (e.g., website visits or other online activity, offline activity, etc.) associated with the person, if any, and/or the like. The persona(s) may be received from an internal data source (e.g., database 114) or from an external system 140.

Next, process 400 may be performed, as a subprocess of process 600. In particular, model 355 may be applied to the job title(s) from the persona(s), received in subprocess 610, to extract one or more named entities (e.g., job responsibility and/or job function) from each job title. Any resulting named entities, extracted from the job title from a persona, may be added as attribute(s) to that persona.

In subprocess 620, persona model 625 may be applied to the persona(s), which include the named entities (e.g., job responsibility and/or job function), derived in process 400, as attributes. In particular, one or more attributes of each persona is input into model 625. In an embodiment, these attributes include at least the job responsibility and job function, and may include one or more other attributes as well. Persona model 625 may be applied to individual personas or, when there are a plurality of personas to be processed, batches of personas, for faster processing.

In an embodiment, persona model 625 is a predictive model that predicts a persona score from the attributes of each persona that were input to persona model 625. Persona model 625 may be the same as or similar to the persona model described in the ‘933 publication. For example, persona model 625 may receive an input comprising or consisting of the job responsibility and/or job function for a given job title for a person, output by model 355, and output a persona score for the person. The persona score may indicate the person’s relevance or importance to sales opportunities or influence over sales opportunities. The persona score may be a number within a range (e.g., 0 to 100), in which one end (e.g., 0) of the range represents no fit and the opposite end (e.g., 100) of the range represents a perfect fit.

Persona model 625 may be trained as described in the ‘933 publication or in any other suitable manner to predict a persona score for a particular set of persona attributes. For example, personal model 625 may be a machine-learning model that is trained, using supervised learning, on a training dataset comprising sets of persona attributes as features, with each set of features labeled with a persona score as the target value for that set of features.

Alternatively, persona model 625 may be a statistical model that calculates the persona score for each persona as a function of the set of attributes (e.g., including job responsibility and job function) for that persona and scores for existing contacts having similar attributes. As one example, persona model 625 may generate a persona score as a weighted value defined by the average score for existing contacts with the same persona attributes, the number of existing contacts with the same persona attributes in the company’s database, normalized by the total volume of existing contacts, and/or the average number of times an existing contact was engaged by sales and marketing prior to an opened sales opportunity. For instance, the persona score may be defined as follows:

$$\begin{matrix}p e r s o n a s c o r e = \\ \frac{c o u n {t}_{s a m e}}{c o u n {t}_{s a m e} + k} ∗ \frac{\text{avg} \left(s c o r {e}_{s a m e}\right) - min \left(s c o r {e}_{a l l}\right)}{max \left(s c o r {e}_{a l l}\right) - min \left(s c o r {e}_{a l l}\right)} + \\ \left(1 - \frac{c o u n {t}_{s a m e}}{c o u n {t}_{s a m e} + k}\right) ∗ \frac{c o u n {t}_{s a m e} - min \left(c o u n {t}_{a l l}\right)}{max \left(c o u n {t}_{a l l}\right) - min \left(c o u n {t}_{a l l}\right)}\end{matrix}$$

wherein countₛₐₘₑ is the number of personas that match the persona being scored (e.g., same job responsibility and job function), k is a factor to ensure that personas with very low volume do not rank as important even if they have a high persona score (e.g., k = 3), avg(scoreₛₐₘₑ) is the average persona score for personas that match the persona being scored, min(scoreₐₗₗ) is the minimum persona score for all personas (e.g., in master people database 635), max(scoreₐₗₗ) is the maximum persona score for all personas, min(countₐₗₗ) is the number of the least common persona (e.g., the persona that occurs least frequently in master people database 635), and max(countₐₗₗ) is the number of the most common persona (e.g., the persona that occurs most frequently in master people database 625). Notably, persona model 625, defined in this manner, accounts for the granularity and diversity among job titles, without having to retrain persona model 625 when updates are needed.

In subprocess 630, the output of persona model 625, which may comprise or consist of the persona score for each persona received in subprocess 610, may be stored, in association with the respective persona(s), in master people database 635. Master people database 635 may comprise a plurality of personas, scored by process 600, for use in one or more downstream functions. In addition, if personal model 625 is implemented as a statistical model, as described above, persona model 625 may utilize data from master people database 635 to calculate the persona scores in subprocess 620.

One example of a downstream function in which scored personas may be used is a persona map. In an embodiment, software (e.g., server application 112 and/or client application 132) is configured to generate a persona map, representing one or more customers of a company that has a user account with platform 110. The persona map may indicate the relative importance or strength of contacts with each job responsibility and job function, along with the status of engagements with contacts having each job responsibility and job function. The relative strength of a contact may be determined based on the persona score associated with that contact, and may be depicted using a color coding and/or in any other suitable manner.

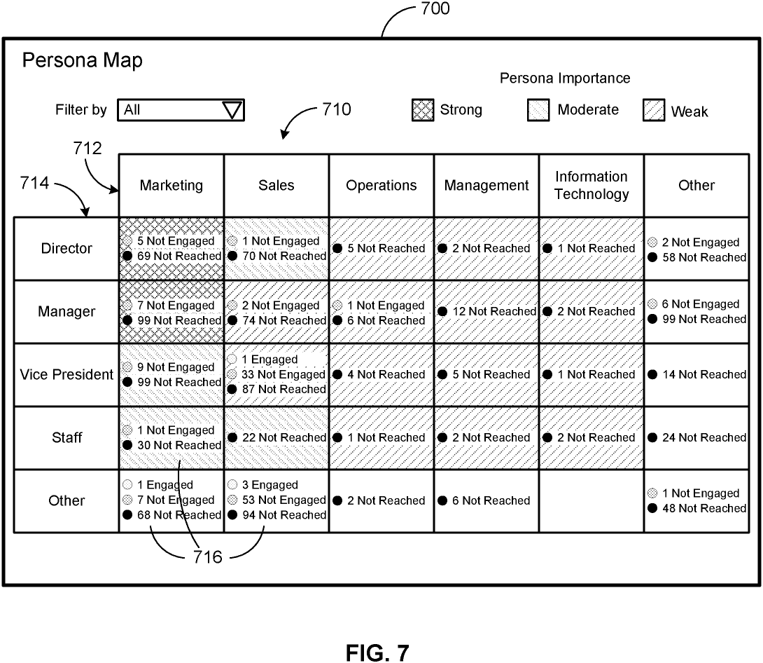

FIG. 7 illustrates an example of a screen 700 comprising a persona map 710, according to an embodiment. Screen 700 may be one screen among a plurality of screens in an overarching graphical user interface that is accessible to the user of a user account with platform 110. Screen 700 may be accessible, within the graphical user interface, via standard navigation through a set of one or more hierarchical menus available to the user (e.g., starting from a dashboard of the user account). Screen 700 may comprise standard components, such as a filter for filtering the data in persona map 710, according to one or more criteria, and a legend that defines the color coding in persona map 710.

Persona map 710 may comprise a two-dimensional grid. A first dimension 712 may represent one named entity, such as job responsibilities, and a second dimension 714 may represent a second named entity, such as job functions. First dimension 712 is illustrated as the vertical dimension (i.e., columns), whereas second dimension 714 is illustrated as the horizontal dimension (i.e., rows). However, it should be understood that these dimensions could easily be reversed, such that first dimension 712 is the horizontal dimension, and second dimension 714 is the vertical dimension. In an embodiment, job responsibilities and/or job functions, for which there are few associated personas and/or which are associated with very low persona scores (e.g., below a predefined threshold), may be grouped together into an “other” column and/or row, respectively.

Each cell 716 in persona map 710 represents a pairing of the named entity of first dimension 712 with the named entity of second dimension 714. In the illustrated embodiment, each cell 716 represents a pairing of a job responsibility with a job function. For example, a cell 716 under the column for “Sales” and in the row for “Manager” represents all personas that are sales managers. Similarly, a cell 716 under the column for “Information Technology” and in the row for “Vice President” represents all personas that are vice presidents of information technology. Each pairing of job responsibility and job function may be associated with any number of personas, including, zero, one, or any plurality of personas.

Which personas are included in persona map 710 may depend on how the data is filtered. For example, the user may select no filter, in which case persona map 710 may comprise data for all personas of all customers of the company. Alternatively, the user may select a filter for a specific market segment, in which case, persona map 710 will only comprise data for all personas of all customer of the company in the selected market segment. It should be understood that any number of other filters may be provided in the same manner.

Each cell 716 may provide a number or count of personas, having the pairing of job responsibility and job function represented by that cell 716, in each of one or more categories. For example, the categories may include personas that have been engaged (e.g., an agent of the company is in active communication with the person associated with the persona), personas that have not been engaged (i.e., no agent of the company has made any attempt to communicate with the person associated with the persona), and/or personas that have been reached (e.g., an agent of the company has reached out to the person associated with the persona, but is not in active communication with that person). It should be understood that these are simply examples of the categories, and that fewer, more, or different categories may be used. Each category in each cell 716 may be selectable (e.g., implemented as a hyperlink), such that a user may select a category for a particular pairing of job responsibility and job function in the cell 716 to see additional details (e.g., on a further screen of the graphical user interface, or in a frame of the same screen 700).

In addition, each cell 716 may be color coded according to the relative strength of the personas having the pairing of job responsibility and job function represented by that cell 716. Again, relative strength may be determined by the relative persona score, with higher persona scores indicating a stronger persona, and lower persona scores indicating a weaker persona. It should be understood that a stronger persona is one with which engagement is more likely to result in a positive outcome to a sales opportunity (e.g., a higher win rate), according to persona model 625. Conversely, a weaker persona is one with which engagement is less likely to result in a positive outcome to a sales opportunity (e.g., a lower win rate), according to persona model 625. In other words, the contacts associated with stronger personas are more important to making a sale than contacts associated with weaker personas. Thus, more effort should be directed towards engaging contacts with stronger personas.

In an embodiment, each cell 716 may have a background color in accordance with a color coding scheme, which assigns a color within a color spectrum (e.g., having a plurality of discrete colors or a range of colors) to each cell 716, based on the persona scores associated with personas having the pairing of job responsibility and job function represented by that cell 716. For example, cells 716 representing pairings of job responsibility and job function, associated with stronger personas, may be colored with bolder background colors (e.g., darker blues), and cells 716 associated with pairings of job responsibility and job function, associated with weaker personas, may be colored with weaker background colors (e.g., lighter blues). Cells 716 associated with pairings of job responsibility and job function, associated with moderate personas, may be colored with moderate background colors (e.g., one or more moderate shades of blue). While only three levels of persona strength (i.e., strong, moderate, and weak) are illustrated in persona map 710, it should be understood that any number of different levels of persona strength may be depicted in persona map 710.

A user may utilize persona map 710 to analyze the behavioral patterns and opportunity data of personas in the past. This may enable the user to uncover the best new contacts and leads to which to reach out or with which to otherwise engage. By understanding the best-fit personas (e.g., via the color coding scheme of persona map 710), the user may select the various categories of personas in one or more cells 716 to more deeply analyze the specific contacts associated with the various personas. Based on this analysis, the user can narrow the focus of marketing or other activities towards those contacts with the highest likelihood of being able to influence a sales opportunity (i.e., move the opportunity closer to a completed sale). For example, marketing efforts may be focused on the strongest personas whom have not yet been engaged or reached.

Advantageously, due to the granularity of the named entities (e.g., job responsibilities and/or job functions) that are output by model 355, a user is able to customize persona map 710 with the particular named entities that align with that user’s understanding of the company’s business. In particular, the user may customize dimensions 712 and/or 714 to include a specific grouping of job responsibilities and/or job functions as a column or row. For example, the user could select a set of granular job responsibilities, output by model 355, into a single group to be represented as a single column in dimension 712. Similarly, the user could select a set of granular job functions, output by model 355, into a single group to be represented as a single row in dimension 714. Thus, a user can build customizable job responsibilities and/or job functions, as groups of granular job responsibilities and/or job functions output by model 355, to be visualized in persona map 710. Non-limiting examples of granular job functions that were derived from a particular implementation of model 355 included “demand generation,” “marketing,” “marketing operations,” “sales,” “business development,” “sales development,” “digital marketing,” “product marketing,” “sales operations,” “growth marketing,” “enterprise account,” “enterprise sales,” “revenue operations,” “inside sales,” “strategic accounts,” “revenue,” “account,” “field marketing,” “marketing programs,” and “marketing communications.”

As one concrete example, a user, representing a company, may want to target a product, being sold by the company, to human resource (HR) professionals. The user may analyze the personas in master people database 635 to identify those job functions that are associated with personas of people in the human resource departments of customers of the company. For example, these personas may include job functions such as “human resource,” “people operations,” “payroll,” and/or the like. The user can collect these job functions into a single grouped job function called “human resources.” Then, the user may configure persona map 710 to display this grouped job function as one of the rows in dimension 714. The information displayed in this row will encompass any personas that are associated with any of the job functions within this grouped job function, and none of the personas that are not associated with the grouped job function.

Another example of a downstream function in which scored personas may be used is contact recommendations. For example, this downstream function may comprise the contact recommendation engine and/or people recommendation engine, described in the ‘933 publication. In both cases, the engine produces a list of recommended contacts to the user. The recommended contacts represent existing or potential customers, which are recommended for engagement. The contacts to be included in the list of recommended contacts may be selected based on their persona scores, which may be determined as described elsewhere herein. It should be understood that contacts with higher persona scores may be recommended more highly than contacts with lower persona scores, the list of recommended contacts may comprise or consist of a predefined number of contacts with the highest persona scores, and/or contacts with low persona scores (e.g., below a predefined threshold) may be omitted from the list of recommended contacts.

In some cases, a recommended contact in the list of recommended contacts may already be known to the user (e.g., already in the user’s CRM system). In this case, the recommendation may be to reach out to that known contact. For example, the list of recommended contacts may be displayed in a screen of the graphical user interface, such that a user can select an input associated with each known contact in the list to initiate a communication (e.g., targeted advertisement, email message, telephone message, etc.) with the selected contact.

In other cases, a recommended contact in the list of recommended contacts may not already be known to the user (e.g., not already in the user’s CRM system). For example, the contact may have been derived from a third-party data source used by platform 110 or by server application 112 itself. In this case, the recommendation is to acquire that contact, in order to be able to reach out to that contact. For example, the list of recommended contacts may comprise an input, associated with each unknown contact in the list. Selection of that input may initiate a transaction to purchase that contact (e.g., via a pre-established or other payment method). Prior to purchasing the contact, the contact may remain masked, with only limited information being displayed, such as the contact’s job responsibility and/or job function, but no contact information. When the user purchases that contact, the contact may be unmasked and/or added to the user’s CRM system.

The above examples represent only a few, non-limiting examples of the downstream functions in which the named entities (e.g., job responsibilities and/or job functions), derived by model 355, may be used. It should be understood that model 355 may be used for any downstream function that would benefit from an understanding of job titles. As other examples of downstream functions, one or more analytics could be applied to the job responsibilities and/or functions, and/or the job responsibilities and/or job functions in the personas may be tuned for different buying stages in a customer’s lifecycle, different market segments, different email campaigns, and/or any other targeted needs.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B’s, multiple A’s and one B, or multiple A’s and multiple B’s.

What is claimed is:

1. A method comprising using at least one hardware processor to, for each of one or more persons:
receive a job title associated with the person;
apply a named-entity recognition model to the job title to identify one or more entities in the job title, wherein the one or more entities comprise one or both of a job responsibility or a job function;
generate a persona comprising one or more attributes of the person, wherein the one or more attributes include the identified one or more entities; and
apply a persona model to the one or more attributes to predict a persona score for the persona, wherein the persona score indicates a relative importance of the person to sales opportunities.

2. The method of claim 1, further comprising, before applying the named-entity recognition model to the job title, standardizing the job title.

3. The method of claim 2, wherein standardizing the job title comprises expanding contractions and abbreviations.

4. The method of claim 1, wherein the named-entity recognition model is a Bidirectional Representations from Transformers (BERT) language model.

5. The method of claim 1, wherein the named-entity recognition model is a Distilled Bidirectional Representations from Transformers (DistilBERT) language model.

6. The method of claim 1, wherein applying the named-entity recognition model to the job title comprises:
applying a tokenizer to the job title to convert the job title into a sequence of tokens; and
tag each token in the sequence of tokens according to a tagging schema for the one or more entities.

7. The method of claim 6, wherein the tagging schema is a beginning, inside, outside, ending, and single (BIOES) tagging schema, in which there is a beginning, inside, ending, and single tag for each of the one or more entities, and an outside tag for any token that does not represent any of the one or more entities.

8. The method of claim 6, wherein the tokenizer is an uncased tokenizer.

9. The method of claim 6, further comprising, prior to applying the named-entity recognition model, training the named-entity recognition model using a training dataset in supervised learning, wherein the training dataset comprises tokenized job titles labeled with ground-truth tags.

10. The method of claim 1, wherein the one or more entities comprise the job responsibility.

11. The method of claim 1, wherein the one or more entities comprise the job function.

12. The method of claim 1, wherein the one or more entities are a plurality of entities, including both the job responsibility and the job function.

13. The method of claim 1, further comprising storing the persona, in association with the persona score, in a master people database.

14. The method of claim 13, wherein the one or more entities are a plurality of entities, including both the job responsibility and the job function, and wherein the method further comprises generating a persona map, based on personas in the master people database, wherein the persona map comprises a first dimension representing a plurality of different job responsibilities, and a second dimension representing a plurality of different job functions.

15. The method of claim 14, wherein the persona map comprises a two-dimensional grid with a plurality of cells, wherein each of the plurality of cells represents a pairing of a job responsibility in the first dimension with a job function in the second dimension.

16. The method of claim 15, wherein each of the plurality of cells indicates a number of personas, having the pairing of job responsibility and job function represented by the cell, in each of one or more categories.

17. The method of claim 15, wherein each of the plurality of cells has a color in accordance with a color coding scheme, wherein the color coding scheme assigns a color within a color spectrum to each of the plurality of cells based on the persona scores associated with personas having the pairing of job responsibility and job function represented by that cell.

18. The method of claim 1, wherein the one or more persons are a plurality of persons, and wherein the method further comprises using the at least one hardware processor to provide the personas, generated for the plurality of persons, to a recommendation engine that generates a list of recommended contacts based on the persona scores of the personas.

19. A system comprising:
at least one hardware processor; and
one or more software modules that are configured to, when executed by the at least one hardware processor, for each of one or more persons,
receive a job title associated with the person,
apply a named-entity recognition model to the job title to identify one or more entities in the job title, wherein the one or more entities comprise one or both of a job responsibility or a job function,
generate a persona comprising one or more attributes of the person, wherein the one or more attributes include the identified one or more entities, and
apply a persona model to the one or more attributes to predict a persona score for the persona, wherein the persona score indicates a relative importance of the person to sales opportunities.

20. A non-transitory computer-readable medium having instructions stored therein, wherein the instructions, when executed by a processor, cause the processor to, for each of one or more persons:
receive a job title associated with the person;
apply a named-entity recognition model to the job title to identify one or more entities in the job title, wherein the one or more entities comprise one or both of a job responsibility or a job function;
generate a persona comprising one or more attributes of the person, wherein the one or more attributes include the identified one or more entities; and
apply a persona model to the one or more attributes to predict a persona score for the persona, wherein the persona score indicates a relative importance of the person to sales opportunities.
